(19) United States
(12) Patent Application Publication
(10) Pub. No.: US 2025/0117456 A1
(43) Pub. Date: Apr. 10, 2025

(54) SYSTEMS AND METHODS FOR SECURING CONTENT

(71) Applicant: Capital One Services, LLC, McLean, VA (US)

(72) Inventors: Ramin MORADI, McLean, VA (US); Tyler MAIMAN, Melville, NY (US); Joshua EDWARDS, Philadelphia, PA (US); Ian KATZMAN, Herndon, VA (US); Shahalam BAIG, Rochester, NY (US); Jackson WESTWOOD, New York, NY (US); Shasanka BHANDARI, McLean, VA (US); Matthew HUNSBERGER, Hoboken, NJ (US)

(73) Assignee: Capital One Services, LLC, McLean, VA (US)

(21) Appl. No.: 18/905,176

(22) Filed: Oct. 3, 2024

Related U.S. Application Data
(60) Provisional application No. 63/587,891, filed on Oct. 4, 2023.
(60) Provisional application No. 63/665,485, filed on Jun. 28, 2024.
(60) Provisional application No. 63/683,063, filed on Aug. 14, 2024.

(51) Int. Cl. G06F 21/10; G06F 16/957; G06F 21/62

(52) U.S. Cl. CPC G06F 21/1066; G06F 16/9577; G06F 21/6245

(57) ABSTRACT

A method may include receiving, using a browser module of a computing device, a video from an application server. The video may be associated with a content element and a digital rights management technology. The method may include forming, using the browser module, an HTML element including the video, and playing, using a video player of the computing device, the video of the HTML element on a display screen associated with the computing device. The method may include receiving, using the computing device, input data, and transmitting, using the computing device, the input data to the application server. The method may include receiving, using the computing device, a determination that the input data represents unexpected input data, from the application server. The method may include, in response to receiving the determination, causing, using the video player, the video of the HTML element to stop playing on the display screen.

### CROSS-REFERENCE TO RELATED APPLICATION(S)

This application claims the benefit of pending U.S. Provisional Patent Application No. 63/587,891, filed on Oct. 4, 2023, pending U.S. Provisional Patent Application No. 63/665,485, filed on Jun. 28, 2024, and pending U.S. Provisional Patent Application No. 63/683,063, filed on Aug. 14, 2024, each of which is incorporated herein by reference in its entirety.

### TECHNICAL FIELD

Various embodiments of this disclosure relate generally to techniques for securing content, and more particularly to systems and methods for securing content of a portal (e.g., a webpage, a website, an application, etc.) in response to fraudulent or potentially fraudulent activity.

### BACKGROUND

Organizations such as banks and healthcare providers seek to protect sensitive information (e.g., confidential information, personally identifiable information, financial information, medical information, etc.) from social engineers. A social engineer is a person or entity who seeks to manipulate a target (e.g., a customer or employee of an organization) into divulging sensitive information that may be used for fraudulent purposes. That is, a social engineer is a person or entity who engages in social engineering. For example, when the target is a user who uses a display screen (also referred to herein as a “screen”) of a computing device to view the user's checking account balance on a bank's website, a social engineer using another computing device may persuade the user to reveal the checking account balance to the social engineer. More specifically, the social engineer may convince the user to share the user's screen displaying the checking account balance with the social engineer, using a remote desktop application (e.g., a screensharing application). Once the screensharing begins, the social engineer may take control of the display screen (e.g., by moving a cursor presented over the bank's website on the display screen), and attempt to fraudulently transfer funds from the user's checking account to the social engineer.

To guard against such social engineering, the bank may employ digital rights management (“DRM”) technologies, which are technologies that limit the use of digital content. However, even if the DRM technologies prevent the social engineer from transferring the funds, the bank may not immediately know about the attempted fraudulent activity.

This disclosure is directed to addressing one or more of the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods for securing content of a portal (e.g., a webpage, a website, an application, etc.) in response to fraudulent or potentially fraudulent activity, are disclosed. Each of the examples disclosed herein may include one or more features described in connection with any of the other disclosed examples.

In one aspect, an exemplary embodiment of a method may include receiving, using a browser module of a computing device, a video from an application server. The video may be associated with a content element and a digital rights management technology. The method may include forming, using the browser module, a HyperText Markup Language (HTML) element including the video received from the application server. The method may include playing, using a video player of the computing device, the video of the HTML element on a display screen associated with the computing device. The method may include receiving, using the computing device, input data, and transmitting, using the computing device, the input data to the application server. The method may include receiving, using the computing device, a determination that the input data represents unexpected input data, from the application server. The method may also include, in response to receiving the determination, causing, using the video player, the video of the HTML element to stop playing on the display screen.

In a further aspect, an exemplary embodiment of a system may include at least one processor and at least one memory having programming instructions stored thereon, which, when executed by the at least one processor, cause the system to perform operations. The operations may include receiving a video from an application server. The video may be associated with a content element and a digital rights management technology. The operations may include forming a HyperText Markup Language (HTML) element including the video received from the application server. The operations may include playing the video of the HTML element on a display screen, receiving input data, and transmitting the input data to the application server. The operations may include receiving a determination that the input data represents unexpected input data, from the application server. The operations may also include, in response to receiving the determination, causing the video of the HTML element to stop playing on the display screen.

In another aspect, an exemplary embodiment of a method may include receiving, using a browser module of a computing device, a video from an application server. The video may be associated with a content element and a digital rights management technology. The method may include forming, using the browser module, a HyperText Markup Language (HTML) element including the video received from the application server. The method may include playing, using a video player of the computing device, the video of the HTML element in a loop on a display screen associated with the computing device. The method may include receiving, using the computing device, input data. The method may include receiving, using the computing device, a determination that the input data represents unexpected input data, from the application server. The method may also include, in response to receiving the determination, causing, using the video player, the video of the HTML element to stop playing on the display screen.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an example environment, according to one or more embodiments.

FIG. 2 depicts a flowchart of an example method, according to one or more embodiments.

FIG. 3 depicts a flow diagram for training a machine learning model, according to one or more embodiments.

FIG. 4 depicts an example computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, the term “screenshare” may refer to a real time or near real time electronic transmission of data displayed on a display screen of a user's computing device to one or more other computing devices. The term “screensharing” and the phrase “being screenshared” may refer to performing a screenshare. In some aspects, screensharing may be performed using a screensharing application (e.g., a video or web conferencing application such as Zoom®, Microsoft's Teams®, or the like, or a remote desktop application such as Microsoft Remote Desktop, Chrome Remote Desktop, or the like). As used herein, the term “screenshot” may represent an image of data displayed on a display screen of a computing device, where the image may be captured or recorded. The term “screenshotting” and the phrase “being screenshotted” may refer to capturing or recording a screenshot. In some aspects, screenshotting may be performed using a screenshotting application (e.g., the Snipping Tool in Microsoft's Windows 11 or an application accessed using a Print Screen key of a keyboard or keypad).

As used herein, the term “sensitive information” may refer to data that is intended for, or restricted to the use of, one or more users or entities. Sensitive information may represent data that is personal, private, confidential, privileged, secret, classified, or in need of protection. Examples of sensitive information may include financial data such as account numbers, credit card account numbers, checking account numbers, virtual card numbers, savings account numbers, account balances, credit card account balances, checking account balances, savings account balances, financial statements, bills, or invoices; personally identifiable information such as a name, address, phone number, social security number, or driver's license number; passport information; medical information such as a patient's medical history, a doctor's summary or diagnosis, or medical test results; academic information such as a student's grades or transcript; business information such as trade secrets, proprietary information, or business strategy information; governmental information such as classified or secret information related to national security or defense; or data that is copyrighted, etc.

As used herein, a “machine learning model” generally encompasses instructions, data, or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as a neural network(s), convolutional neural network(s), regional convolutional neural network(s), mask regional convolutional neural network(s), deformable detection transformer(s), linear regression, logistical regression, random forest, gradient boosted machine (GBM), deep learning, or a deep neural network. Supervised or unsupervised training may be employed. For example, supervised learning may include providing training data and labels corresponding to the training data, e.g., as ground truth. Unsupervised approaches may include clustering, classification or the like. Any suitable type of training may be used, e.g., stochastic, gradient boosted, random seeded, recursive, epoch or batch-based, etc.

In the following description, embodiments will be described with reference to the accompanying drawings. As will be discussed in more detail below, various embodiments, methods, and systems for securing content of a portal (e.g., a webpage, a website, an application, etc.) in response to fraudulent or potentially fraudulent activity, are described.

In an exemplary use case, a customer of a bank may use a computing device (e.g., a laptop) to obtain financial information. More specifically, the customer may use a browser presented on a display screen of the computing device to load a webpage that is associated with the bank, and on which the customer anticipates viewing the customer's checking account balance and a button to transfer funds from the checking account balance to another account. In some aspects, the checking account balance and the button may represent sensitive information (or content). Sensitive information (or content) may refer to data that is intended for, or restricted to the use of, one or more users or entities (e.g., the customer and the bank).

As the webpage is loaded, an application server associated with the bank may generate a video that includes a single image frame (or video frame), where the image frame represents or depicts the checking account balance and the button. In some aspects, the video may be protected using a DRM technology, and be configured to play the image frame in a loop on the display screen when fraudulent (or potentially fraudulent) activity is not detected on the computing device. The video may also be configured to play the image frame in a loop on the display screen when the display screen is not being screenshared or screenshotted. Further, the video may be configured to not play (or be blocked from playing) the image frame in a loop on the display screen when fraudulent activity (or potentially fraudulent) activity is detected on the computing device, or when the display screen is being screenshared or screenshotted. Accordingly, the video may be configured to prevent the checking account balance and button from being shared with (or accessed by) a social engineer or potential social engineer.

Once the video is generated, the application server may transmit the video to the computing device (e.g., via a content decryption module). In some aspects, the browser of the computing device may form an HTML element including the video, where the HTML element is a component of an HTML page that represents the webpage associated with the bank. In some embodiments, an operating system of the computing device may output the video of the HTML element to the display screen, while the browser outputs the remainder of the webpage (or a portion of the webpage excluding the checking account balance and the button) to the display screen. The video of the HTML element may be configured to be overlaid on, or presented adjacent to, the remainder of the webpage on the display screen.

In some aspects, the computing device may be configured to receive and track one or more inputs, such a movement or clicks of a mouse associated with the computing device, or keypresses of a keyboard associated with the computing device. The computing device may also be configured to transmit such inputs to the application server, which may be configured to track and analyze the inputs and determine whether the inputs are associated with (or correspond to) the customer.

In some embodiments, where a social engineer (or potential social engineer) approaches the customer in person and begins to take control of the computing device by, for example, moving the mouse associated with the computing device, the computing device may transmit data representing the movement of the mouse to the application server. Subsequently, the application server may determine that the transmitted data does not correspond to the customer (or is unexpected), and the application server may transmit this determination to the computing device. In response to receiving the determination, the computing device may cause the video to stop playing on the display screen, so that the social engineer (or potential social engineer) cannot view the checking account balance and button, or attempt to transfer funds from the customer's checking account using the button.

In some other embodiments, where the customer shares the display screen with a social engineer (or potential social engineer) using a remote desktop application, and where the social engineer takes control of the computing device (remotely) to, for example, move a cursor presented on the display screen, the computing device may cause the video to stop playing on the display screen (e.g., when the screensharing begins or is initiated) so that the social engineer cannot view or access the checking account balance or button. Further, the computing device may transmit data representing the movement of the cursor to the application server, and the application server may determine that the transmitted data does not correspond to the customer (or is unexpected). The application server may subsequently log this determination (e.g., for the bank's review) and optionally transmit a notification to the computing device for display on the display screen, where the notification may warn the customer about risks associated with sharing the display screen with others.

Accordingly, the computing device and the application server may be used to detect fraudulent (or potentially fraudulent) activity in real time or near real time, and to safeguard sensitive information and digital tools (e.g., buttons, toggle switches, etc.) from such activity. Moreover, unlike conventional techniques for tracking inputs to a computing device on which a webpage is displayed, embodiments of the present disclosure may track such inputs without using cookies or requiring consent from a user of the computing device.

While the example above involves a webpage and content including a checking account balance and button, it should be understood that techniques according to this disclosure may be adapted to any suitable type of program (e.g., a website, portal, application, browser extension, plugin, etc.) and content (e.g., sensitive information, non-sensitive information, text data, image data, audio data, web applications, toggle switches, etc.), respectively. It should also be understood that the example above is illustrative only. The techniques and technologies of this disclosure may be adapted to any suitable activity.

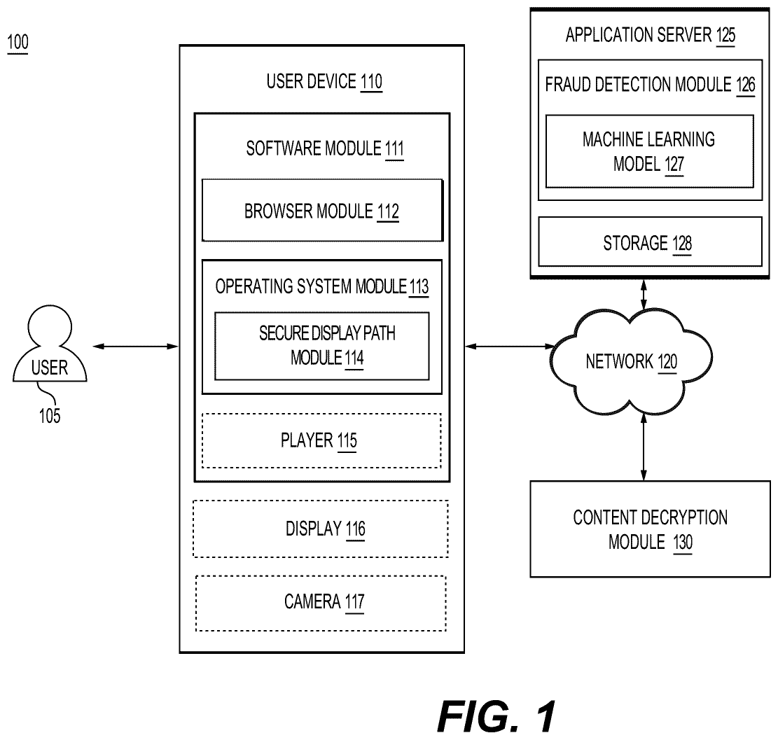

FIG. 1 depicts an example environment 100 that may be utilized with techniques presented herein. In some aspects, the environment 100 may be an embodiment of (i) the environment 100 described in U.S. Provisional Application 63/587,891, filed on Oct. 4, 2023, (ii) the environment 100 described in U.S. Provisional Application 63/665,485, filed Jun. 28, 2024, or (iii) the environment 100 described in U.S. Provisional Application 63/683,063, filed Aug. 14, 2024, where each of these U.S. provisional applications is incorporated by reference herein in its entirety. As shown in FIG. 1, the environment 100 may include a user device 110, a network 120 (e.g., an electronic network), an application server 125, and a content decryption model 130 (also referred to herein as the “CDM 130”). In some aspects, the user device 110, the application server 125, and the CDM 130 may communicate with one another in any arrangement across the network 120. The user device 110 may be associated with a user 105. In some embodiments, the user 105 may be a customer or employee of, or contractor for, a company, business, or organization (e.g., a bank, a hospital, a university, etc.), or the like. Further, in some embodiments, the company, business, or organization may be associated with (e.g., own, rent, or control) the user device 110. In some other embodiments, the user 105 may own, rent, or control the user device 110. Further, in some embodiments, the user 105 may be an authorized user of the user device 110 and a portal accessed using the user device 110.

The user device 110 may be configured to enable the user 105 to access or interact with the network 120, the application server 125, and the CDM 130, in the environment 100. For example, the user device 110 may be a computer system such as a desktop computer, a laptop, a workstation, a mobile device, a tablet, etc. In some embodiments, the user device 110 may include one or more software modules, which may represent electronic application(s) such as a program, a platform, a plugin, or a browser extension, installed on a memory of the user device 110. For example, as shown in FIG. 1, the user device 110 may include a software module 111 that may represent (or include), for example, a browser module 112, an operating system module 113, and optionally a player 115. The user device 110 may also optionally include a display 116 and a camera 117.

The player 115 may represent a video player configured to play back one or more videos, or present image frames (or video frames) of one or more videos on a display screen. In some embodiments, the player 115 may be included in the browser module 112 or the operating system module 113 (not shown in FIG. 1). In some other embodiments, the player 115 may represent hardware included in the user device 110 (not shown in FIG. 1). In some embodiments, the player 115 may represent an interactive video player, which is a video player configured to play back a video, where a user (e.g., the user 105) may interact with the video (e.g., by selecting a button presented in the video) during the playback on a display screen. Further, the player 115 may be configured to detect and track one or more inputs provided by the user 105 (or another user of the user device 110) to the display screen. For example, where the player 115 is used to play or present a video on the display 116, the player 115 may detect and track the position or movement of a cursor presented over the video, or the position or movement of a finger or stylus (e.g., of the user 105) in contact with the video presented on the display 116. In some embodiments, the player 115 may represent a transparent layer that is overlaid on a video that is presented or being played on the display 116.

In some embodiments, the user device 110 may include the display 116, which may represent a display screen configured to display or present data, optionally using the player 115. In some aspects, the display 116 may receive data for display from the browser module 112 or the operating system module 113.

Further, in some embodiments, the user device may include the camera 117 (e.g., an optical sensor). The camera 117 may be configured to image (e.g., take a video or photo of, or scan) one or more objects in a field of view of the camera 117. Further, the camera 117 may be configured to track a position or movement of one or more eyes of a user (e.g., the user 105) viewing the display 116, using eye tracking software operating on the user device 110, for example. The camera 117 may also be configured to track (or determine) an amount of time at least one eye of a user viewing the display 116, is positioned at a particular orientation (e.g., to gaze at particular content presented on the display 116).

In some aspects, the user device 110 may be configured to receive (or detect) and track one or more inputs (e.g., input data) from a user (e.g., the user 105 or another user) of the user device 110. For example, where a mouse is associated with (e.g., coupled to) the user device 110, the user device 110 may be configured to detect and track a position or movement of the mouse (where the position or movement of the mouse may correspond to, or mirror, a position or movement, respectively, of a cursor presented on the display 116). As another example, where the user device 110 includes or is associated with a trackpad, the user device 110 may be configured to detect and track a position or movement of a finger (e.g., of the user 105) in contact with the trackpad (where the position or movement of the finger may correspond to, or mirror, a position or movement, respectively of a cursor presented on the display 116). As another example, where a keyboard is associated with (e.g., coupled to or included in) the user device 110, the user device 110 may be configured to detect and track one or more keypresses of the keyboard (including, for example, the timing, rhythm, or sequencing of the keypresses). As yet another example, where the camera 117 is associated with (e.g., included in or coupled to) the user device 110, the user device 110 may be configured to use the camera 117 and eye tracking software operating on the user device 110 to identify and track the position of one or more eyes of a user viewing the display 116. The user device 110 may also be configured to use the camera 117 and eye tracking software to determine the amount of time at least one eye of a user viewing the display 116 is positioned at a particular orientation (or angle) relative to the display 116.

In some aspects, the user device 110 may also be configured to detect or track data (or content) presented on the display 116. For example, and as explained above, the user device 110 may be configured to track a position or movement of a cursor presented on the display 116. The user device 110 may also be configured to track the amount of time during which a video is played or presented on the display 116, or the amount of time particular data (or content) is displayed on the display 116.

The browser module 112 may include one or more browsers (e.g., web browsers or applications for accessing and viewing content on the internet, the World Wide Web, a cloud platform, etc.). In some embodiments, the browser module 112 may be configured to communicate with the operating system module 113, the player 115, the display 116, the camera 117, the network 120, and the application server 125 and the CDM 130, via the network 120. For example, in response to the user 105 inputting a web address (or uniform resource locator) to the browser module 112 (e.g., using the display 116 or a keyboard or other input/output device associated with the user device 110), the browser module 112 may be configured to transmit a request for a webpage (or website, portal, application, etc.) associated with the web address, to the application server 125 via the network 120. The browser module 112 may also be configured to receive the webpage from the application server 125 via the network 120. In some aspects, the browser module 112 may be configured to load, render, or output the webpage (or a portion of the webpage) to the display 116 directly, or indirectly via the operating system module 113.

In some aspects, the webpage received by the browser module 112 from the application server 125 may include one or more content elements (or represent a single content element). In some aspects, a content element may represent data such as text data (e.g., letters, numbers, symbols, metadata, or alt text), image data (e.g., an image, a graphic, a sequence of image frames, or a video), or audio data (e.g., a sequence of audio frames). In some embodiments, a content element may be dynamic (e.g., configured to change over time), such as an animated graphic or a video advertisement. Further, in some embodiments, a content element may be interactive (e.g., configured to respond to an input from a user of a computing device), such as a button, a toggle switch, a field configured to display text, a link (e.g., a hyperlink), an icon that may be selected to launch an application, text that may be highlighted or selected (e.g., using a cursor), or one or more images that may be highlighted or selected (e.g., using a cursor). In some aspects, a content element may include one or more content elements. Further, a content element may represent data included in, or referred by, an HTML element of an HTML page corresponding to (or representing) the webpage. An HTML element may represent a component of an HTML page, and may include, for example, a start tag, an end tag, and as noted above, a content element or a reference to a content element (e.g., a link, hyperlink, address, or path to a content element). Further, in some embodiments, an HTML element may include one or more HTML elements (e.g., nested HTML elements).

In some embodiments, one or more content elements of the webpage may include sensitive information or non-sensitive information. As explained above, sensitive information may refer to data that is intended for, or restricted to the use of, one or more users or entities (e.g., the user 105 and an organization associated with the application server 125). Moreover, sensitive information may represent data that is personal, private, confidential, privileged, secret, classified, or in need of protection. Sensitive information may further represent, for example, financial data such as account numbers, credit card account numbers, checking account numbers, savings account numbers, virtual card numbers, account balances, credit card account balances, checking account balances, savings account balances, financial statements, ledgers, bills, or invoices; personally identifiable information such as a name, address, phone number, social security number, or driver's license number; passport information, medical information such as a patient's medical history, a doctor's summary or diagnosis, or medical test results; academic information such as a student's grades or transcript; business information such as trade secrets, proprietary information, or business strategy information; governmental information such as classified or secret information related to national security or defense; or data that is copyrighted, etc.

In some embodiments, the browser module 112 may be configured to determine whether one or more content elements of the webpage include sensitive information. The browser module 112 may also be configured to transmit this determination to the application server 125 via the network 120. In some embodiments, the browser module 112 may be configured to receive one or more content elements of the webpage from the application server 125, optionally via the CDM 130. For example, the browser module 112 may be configured to receive a DRM-protected video that includes an image frame (or video frame) depicting the one or more content elements of the webpage, from the application server 125 via the CDM 130. The browser module 112 may also be configured to communicate with the operating system module 113 (e.g., a secure display path module 114). For example, the browser module 112 may be configured to transmit one or more content elements (e.g., a DRM-protected video or other data) to the operating system module 113 (e.g., the secure display path module 114).

In some embodiments, the operating system module 113 may include one or more operating systems. In some aspects, an operating system may represent software configured to (i) manage hardware and software resources of the user device 110 or (ii) provide services for applications associated with the user device 110. Further, the operating system module 113 may be configured to communicate with the browser module 112, the player 115, the display 116, the camera 117, and the application server 125 and the CDM 130, via the network 120. In some embodiments, the operating system module 113 may include the secure display path module 114 (also referred to herein as the “secure display path 114”). In some aspects, the secure display path 114 may represent (or include) one or more DRM technologies (or DRM functions) used to protect or secure content element(s) that the secure display path 114 receives (or retrieves) from the browser module 112, the application server 125, or the CDM 130. The secure display path 114 may be native (or specific) to a respective operating system of the operating system module 113. In some embodiments, the secure display path 114 may represent Microsoft's Protected Media Path, for example.

In some aspects, the secure display path module 114 may be configured to load, render, or output to the display 116, one or more content elements of a webpage for presentation, optionally while the browser module 112 concurrently loads, renders, or outputs to the display 116, the remainder (or a portion of) of the webpage for presentation. For example, where a content element of a webpage represents a DRM-protected video that includes an image frame depicting sensitive information (e.g., a checking account balance), the secure display path module 114 may load, render, or output the DRM-protected video to the display 116 while the browser module 112 concurrently loads, renders, or outputs to the display 116, the remainder (or a portion) of the webpage (e.g., a portion of the webpage that excludes the DRM-protected video and the sensitive information). In some embodiments, the DRM-protected video may be presented over background color(s) of the remainder (or a portion) of the webpage, on the display 116. As another example, where a first content element of a webpage represents a DRM-protected video that includes an image frame that is transparent (and does not depict or represent sensitive information) and where a second content element of the webpage represents sensitive information (e.g., a checking account balance), the secure display path module 114 may load, render, or output the first and second content elements to the display 116, while the browser module 112 loads, renders, or outputs to the display 116, the remainder (or a portion) of the webpage. In some aspects, the first content element (the DRM-protected video) may be presented on top of (or be overlaid on) the second content element (the sensitive information) on the display 116, which may be overlaid on the remainder (or a portion) of the webpage. Further, when the first content element (the DRM-protected video) is played on the display 116 (e.g., when the transparent image frame of the DRM-protected video is played in a loop), the user 105 may view the second content element (the sensitive information) presented under the first content element on the display 116. As used herein, the terms “image frame that is transparent” and “transparent image frame” refer to an image frame of a video, where the image frame is clear (e.g., see-through or invisible, from the perspective of a user viewing the image frame on the display 116), and does not depict or represent any sensitive information. As yet another example, where a content element of a webpage represents a DRM-protected video that includes an image frame that depicts the entire webpage, the secure display path module 114 may load, render, or output the content element to the display 116.

In some aspects, the secure display path 114 may be configured to protect (or secure) one or more content elements (e.g., one or more pre-determined or pre-selected content elements) by blocking or preventing the one or more content elements from being loaded, rendered, or output to or played on the display 116, when at least one of the following conditions occurs: (i) the user device 110 determines or receives determination that someone other than the user 105 (or someone not authorized to view content presented or played on the display 116) is viewing or controlling the user device 110, or (ii) the display 116 is being screenshared (e.g., using a remote desktop application or screensharing) or screenshotted (e.g., using a screenshotting application). Further, the secure display path 114 may be configured to load, render, output to, or support the playing of (e.g., using the player 115), one or more content elements to the display 116 when at least one of the following conditions occurs: (i) the user device 110 determines or receives a determination that only the user 105 (or only user(s) authorized to view content presented or played on the display 116) is viewing or controlling the user device 110, or (ii) the display 116 is not being screenshared or screenshotted.

The application server 125 may be a computing system such as a server, a workstation, a desktop computer, a laptop, a mobile device, a tablet, etc. In some examples, the application server 125 may be associated with (or include) a cloud computing platform with scalable resources for computation or data storage. The application server 125 may run one or more applications locally or using the cloud computing platform, to perform various computer-implemented methods described in this disclosure. In some embodiments, the application server 125 may be associated with (e.g., owned, rented, or controlled by) a company, a business, or an organization, such as a bank, a hospital, a university, or a merchant, etc. In some aspects, the application server 125 may be configured to communicate with the user device 110 and the CDM 130, via the network 120.

For example, the application server 125 may be configured to transmit an HTML page (or file) corresponding to a webpage to the browser module 112 or the operating system module 113, via the network 120. In some embodiments, the application server 125 may be configured to receive a notification (or determination) from the browser module 112 that one or more content elements of the HTML page include sensitive information. Further, in some embodiments, the application server 125 may be configured to determine whether one or more content elements of the HTML page (or webpage) include sensitive information. In response to determining (or receiving a determination) that a content element includes sensitive information, the application server 125 may generate and encrypt a DRM-protected video that includes either (i) a transparent image frame configured to be presented over the sensitive information on the display 116 or (ii) an image frame that depicts or represents the sensitive information. In some aspects, the application server 125 may be configured to transmit the encrypted, DRM-protected video to the CDM 130 (which may decrypt the encrypted DRM-protected video and transmit the decrypted DRM-protected video to the user device 110).

As shown in FIG. 1, the application server 125 may include a fraud detection module 126 and a storage 128 (e.g., a memory). The fraud detection module 126 may represent a software module configured to detect fraudulent (or potentially fraudulent) activity on the user device 110. In some aspects, the fraud detection module may be configured to receive, from the user device 110, input data (e.g., data representing a position or movement of a mouse associated with the user device 110, etc.), and optionally store the input data in the storage 128. Further, as shown in FIG. 1, the fraud detection module 126 may include a machine learning model 127. The machine learning model 127 may represent a trained machine learning model configured to receive input data from the user device 110, and to output a determination or prediction regarding an identity of a user who provided the input data to the user device 110. Put differently, the machine learning model 127 may be configured to receive and analyze input data from the user device 110 (e.g., data representing one or more keypresses of a keyboard associated with the user device 110), and to output a prediction or determination as to whether the received input data represents expected input data or unexpected input data. Expected input data may represent input data provided by a user authorized to control the user device 110, or to view content presented on the display 116. Unexpected input data may represent input data provided by a social engineer, potential social engineer, or a user not authorized to (i) control the user device 110 or (ii) view content presented on the display 116.

In some aspects, the machine learning model 127 may be configured to output the determination regarding whether input data represents expected or unexpected input data based on tracking the input data fed to the machine learning model 127, applying the tracked input data to one or more metrics (e.g., usage metrics) associated with a user of the user device 110, or comparing the tracked input data to one or more patterns (e.g., patterns of usage data) associated with a user of the user device 110 (e.g., the user 105). For example, the machine learning model 127 may be configured to determine whether input data represents expected input data (or unexpected input data) based on comparing or mapping the input data to data representing one or more of the following usage patterns or metrics: how the user 105 tends to move, position, or click a mouse associated with the user device 110; how the user 105 tends to move, position, or make a selection, using the user 105′s finger or a stylus on a trackpad (or the display 116) associated with the user device 110; what keys and what sequence of keys the user 105 tends to press on a keyboard associated with the user device 110; the timing or rhythm of keys the user 105 tends to press on the keyboard; where the user 105 tends to look on the display 116 (or on a webpage or video presented or played on the display 116); for how long the user 105 tends to look continuously at the display 116 or particular content elements presented on the display 116; or how the user 105 tends to move or position a cursor presented on the display 116. In some aspects, data representing such patterns may be (or serve as) a signature or indicator of the user 105. Further, in some aspects, the machine learning model 127 may be trained using input data provided by one or more users to one or more computing devices. In some embodiments, the machine learning model 127 may continue to be trained during operation, as the machine learning model 127 receives input data from the user device 110.

In some embodiments, when the machine learning model 127 outputs a determination that received input data represents expected input data (e.g., input data provided or likely provided by the user 105 to the user device 110), the fraud detection module 126 may store the determination in the storage 128, delete the determination, or transmit the determination to the user device 110. When the machine learning model 127 outputs a determination that received input data represents unexpected input data (e.g., input data provided or likely provided by someone other than the user 105, such as a social engineer or potential social engineer), the fraud detection module 126 may store the determination in the storage 128, and transmit the determination to the user device 110 (which may cause, for example, one or more DRM-protected videos being played on the display 116 to stop playing in order to shield any sensitive information presented in or under the DRM-protected videos from a social engineer or potential social engineer viewing the display 116). Accordingly, the fraud detection module 126 may be used to provide near real time, or real time, detection of fraudulent or potentially fraudulent activity on the user device 110, and in response, the user device 110 may secure any sensitive information presented on the display 116.

In some aspects, the CDM 130 (or DRM platform 130) may be configured to communicate with the user device 110 and the application server 125, via the network 120. For example, the CDM 130 may be configured to receive an encrypted, DRM-protected video from the application server 125. The CDM 130 may also be configured to decrypt the encrypted, DRM-protected video, and transmit the decrypted, DRM-protected video to the user device 110 (e.g., to the browser module 112 or the operating system module 113).

In various embodiments, the network 120 may be a wide area network (“WAN”), a local area network (“LAN”), personal area network (“PAN”), or the like. In some embodiments, network 120 may include the Internet, and support the transmission of information and data between various systems online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page,” “website,” or “webpage” generally encompasses a location, data store, or the like that is, for example, hosted or operated by a computer system so as to be accessible online, and that may include data configured to cause a program such as a browser to perform operations such as send, receive, or process data, generate a visual display or an interactive interface, or the like.

Although depicted as separate components in FIG. 1, it should be understood that a component or portion of a component in the environment 100 may, in some embodiments, be integrated with or incorporated into one or more other components. For example, in some embodiments, at least a portion of the application server 125 or the CDM 130 may be integrated into the user device 110. In some embodiments, operations or aspects of one or more of the components discussed above may be distributed amongst one or more other components. Any suitable arrangement or integration of the various systems and devices of the environment 100 may be used. Further, in some embodiments, the environment 100 may include multiple user devices 110, multiple application servers 125, or multiple CDMs 130.

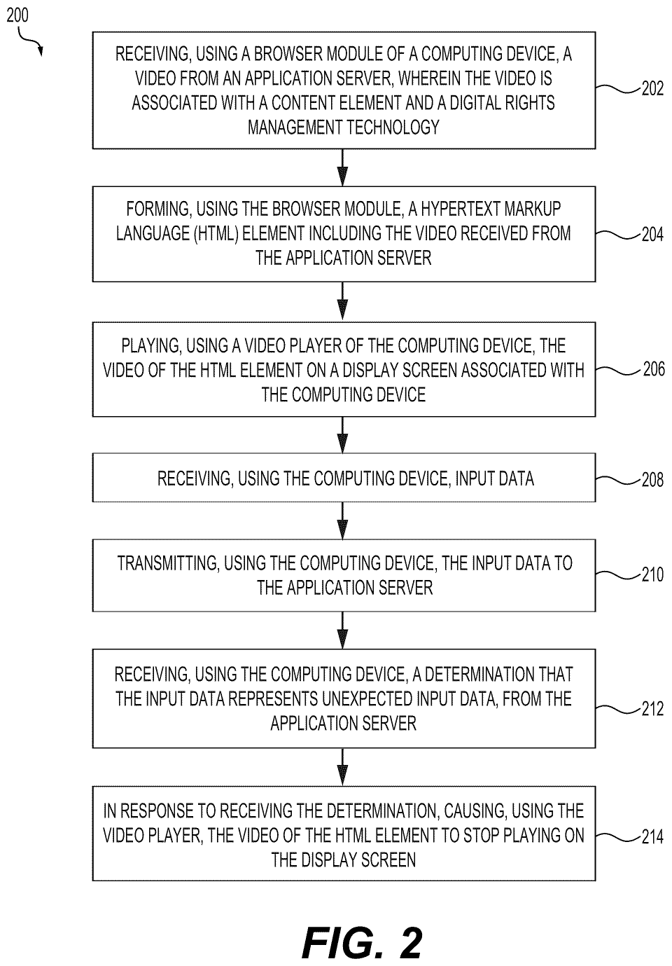

FIG. 2 is a flowchart illustrating a method 200 for securing content of a portal (e.g., a webpage, a website, an application, etc.), according to one or more embodiments of the present disclosure. In some aspects, the method 200 may be used to secure content of a portal displayed on a display screen of a computing device, in response to fraudulent or potentially fraudulent activity that is detected on the computing device. In some embodiments, the method 200 may be performed by the user device 110.

As shown in FIG. 2, the method 200 may include receiving, using a browser module (e.g., the browser module 112) of a computing device (e.g., the user device 110), a video from an application server (e.g., the application server 125), where the video is associated with a content element and a digital rights management technology (202). In some embodiments, the browser module may receive the video from the application server via a content decryption module (e.g., the CDM 130). In some aspects, the content element may represent a portion, or all of, a webpage, and include sensitive information. Further, in some embodiments, the video may include only one image frame (or video frame), where the image frame represents the content element. In some other embodiments, the video may include only one image frame (or video frame), where the image frame represents a transparent image frame, and where the video may be configured to be overlaid on the content element on a display screen (e.g., the display 116) associated with the computing device. In some aspects, the video may be configured to play in a loop on the display screen when fraudulent or potentially fraudulent activity is not detected on the computing device, and when the display screen is not being screenshared or screenshotted.

The method 200 may include forming, using the browser module, a HyperText Markup Language (HTML) element including the video received from the application server (204). In some embodiments, where the video of the HTML element includes an image frame representing the content element, the method 200 may include outputting, using an operating system (e.g., the operating system module 113) of the computing device, the video to the display screen. In some other embodiments, where the video of the HTML element includes a transparent image frame, the method 200 may include outputting, using the operating system or the browser module, the video to the display screen, and outputting, using the operating system, the content element to the display screen, for display under the outputted video.

The method 200 may include playing, using a video player (e.g., the video player 115) of the computing device, the video of the HTML element on the display screen associated with the computing device (206). In some embodiments, the video player may be configured to track at least one of a position of a cursor displayed on the display screen or a position of a finger or stylus in contact with the display screen.

The method 200 may include receiving, using the computing device, input data (208). In some embodiments, the input data may represent at least one of the following: movement of a mouse associated with the computing device; movement of a cursor displayed on the display screen; a position of the cursor displayed on the display screen; an amount of time during which the video has been playing on the computing device; an amount of time during which an eye of a user associated with the computing device has been directed at the display screen; an amount of time during which the eye of the user has been directed at the video on the display screen; movement of the eye of the user associated with the computing device; or a position on the display screen of a finger or stylus, associated with the user, and in contact with the display screen.

The method 200 may include transmitting, using the computing device, the input data to the application server (210). The method 200 may further include receiving, using the computing device, a determination that the input data represents unexpected input data, from the application server (212). In some embodiments, the unexpected input data may represent data associated with a user unauthorized to view the video on the display screen. Further, in some embodiments, the determination that the input data represents unexpected input data may be (or represent) a determination output from a machine learning model (e.g., the machine learning model 127).

The method 200 may include, in response to receiving the determination, causing, using the video player, the video of the HTML element to stop playing on the display screen (214). In some embodiments, the video player and the operating system may be used to cause the video of the HTML element to stop playing on the display screen. Further, in some embodiments, where multiple videos associated with content elements and the digital rights management technology are included in one or more HTML elements and played on the display screen, the method 200 may include, in response to receiving the determination, causing, using the video player or the operating system, one or more of the multiple videos (e.g., one or more pre-determined or pre-selected videos of the multiple videos) to stop playing on the display screen.

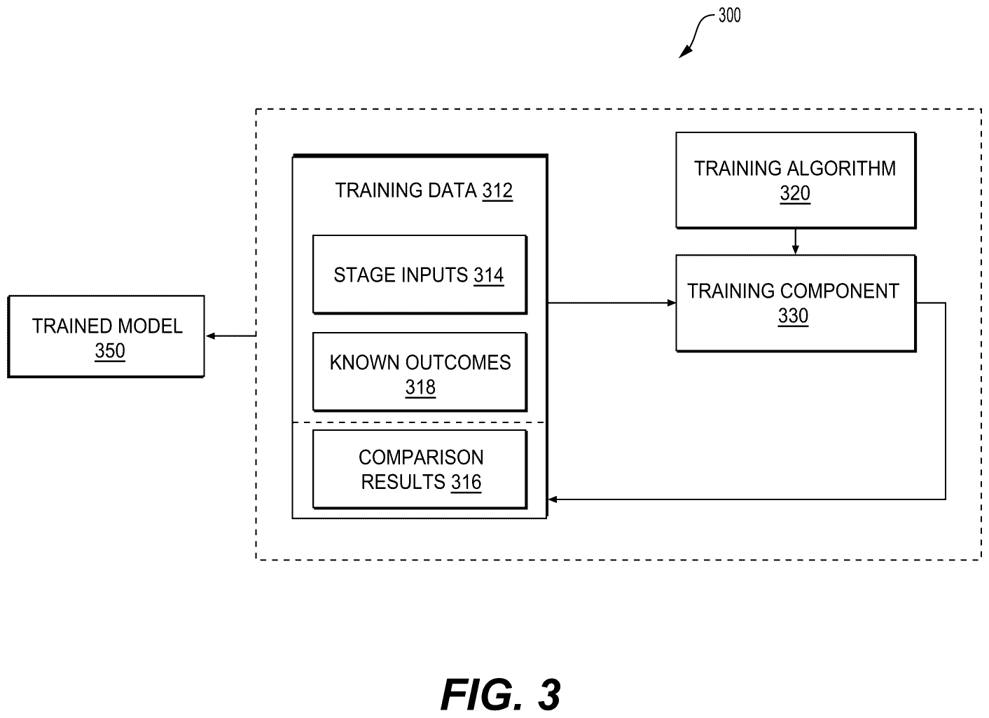

As disclosed herein, one or more implementations disclosed herein may be applied by using a machine learning model (e.g., the machine learning model 127). A machine learning model as disclosed herein may be trained using one or more components or steps of FIGS. 1, 2, and 4. As shown in flow diagram 300 of FIG. 3, training data 312 may include one or more of stage inputs 314 and known outcomes 318 related to a machine learning model to be trained. The stage inputs 314 may be from any applicable source including a component or set shown in the figures provided herein. In some embodiments, the stage inputs 314 may represent input data received by a computing device (e.g., from a mouse or keyboard associated with the computing device). The known outcomes 318 may be included for machine learning models generated based on supervised or semi-supervised training. In some embodiments, the known outcomes 318 may represent determinations regarding the identities of users or entities associated with the stage inputs 314 (or determinations regarding whether the stage inputs 314 represent expected input data or unexpected input data). An unsupervised machine learning model might not be trained using known outcomes 318. Known outcomes 318 may include known or desired outputs for future inputs similar to or in the same category as stage inputs 314 that do not have corresponding known outputs.

The training data 312 and a training algorithm 320 may be provided to a training component 330 that may apply the training data 312 to the training algorithm 320 to generate a trained machine learning model 350 (e.g., the machine learning model 127). According to an implementation, the training component 330 may be provided comparison results 316 that compare a previous output of the corresponding machine learning model to apply the previous result to re-train the machine learning model. The comparison results 316 may be used by the training component 330 to update the corresponding machine learning model. The training algorithm 320 may utilize machine learning networks or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, or discriminative models such as Decision Forests and maximum margin methods, or the like. The output of the flowchart 300 may be a trained machine learning model 350.

A machine learning model disclosed herein may be trained by adjusting one or more weights, layers, or biases during a training phase. During the training phase, historical or simulated data may be provided as inputs to the model. The model may adjust one or more of its weights, layers, or biases based on such historical or simulated information. The adjusted weights, layers, or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

In general, any process or operation discussed in this disclosure that is understood to be computer-implementable, such as the process (or method) illustrated in FIG. 2, may be performed by one or more processors of a computer system, such as any of the systems or devices in the environment 100 of FIG. 1, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIG. 1. One or more processors of a computer system may be included in a single computing device or distributed among a plurality of computing devices. A memory of the computer system may include the respective memory of each computing device of the plurality of computing devices.

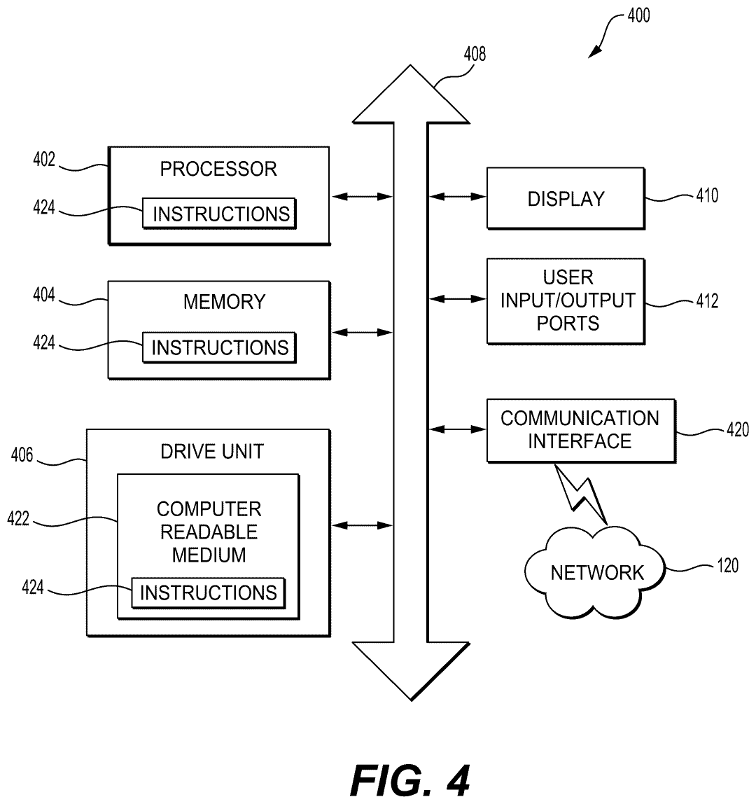

FIG. 4 is a simplified functional block diagram of a computer 400 that may be configured as a device for executing the method 200 of FIG. 2, according to exemplary embodiments of the present disclosure. For example, in some embodiments, the computer 400 may be configured as the user device 110, according to exemplary embodiments of this disclosure. In some other embodiments, the computer 400 may be configured as the application server 125, according to exemplary embodiments of this disclosure. In some other embodiments, the computer 400 may be configured as the CDM 130, according to exemplary embodiments of this disclosure. In various embodiments, any of the devices or systems herein may be a computer 400 including, for example, a data communication interface 420 for packet data communication. The computer 400 also may include a central processing unit (“CPU”) 402, in the form of one or more processors, for executing program instructions. The computer 400 may include an internal communication bus 408, and a storage (or drive) unit 406 (such as ROM, HDD, SDD, etc.) that may store data on a computer readable medium 422, although the computer 400 may receive programming and data via network communications. The computer 400 may also have a memory 404 (such as RAM) storing instructions 424 for executing techniques presented herein, although the instructions 424 may be stored temporarily or permanently within other modules of computer 400 (e.g., processor 402 or computer readable medium 422). The computer 400 also may include input and output ports 412 or a display (or display screen) 410 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method comprising:
receiving, using a browser module of a computing device, a video from an application server, wherein the video is associated with a content element and a digital rights management technology;
forming, using the browser module, a HyperText Markup Language (HTML) element including the video received from the application server;
playing, using a video player of the computing device, the video of the HTML element on a display screen associated with the computing device;
receiving, using the computing device, input data;
transmitting, using the computing device, the input data to the application server;
receiving, using the computing device, a determination that the input data represents unexpected input data, from the application server; and
in response to receiving the determination, causing, using the video player, the video of the HTML element to stop playing on the display screen.

2. The method of claim 1, wherein the unexpected input data represents data associated with a user unauthorized to view the video on the display screen.

3. The method of claim 1, wherein the input data represents at least one of:
movement of a mouse associated with the computing device;
movement of a cursor displayed on the display screen;
a position of the cursor displayed on the display screen;
an amount of time during which the video has been playing on the computing device;
an amount of time during which an eye of a user associated with the computing device has been directed at the display screen;
an amount of time during which the eye of the user has been directed at the video on the display screen;
movement of the eye of the user associated with the computing device; or
a position on the display screen of a finger or stylus, associated with the user, and in contact with the display screen.

4. The method of claim 1, wherein the determination that the input data represents unexpected input data represents a determination output from a machine learning model.

5. The method of claim 1, wherein causing, using the video player, the video of the HTML element to stop playing on the display screen comprises:
causing, using the video player and an operating system of the computing device, the video of the HTML element to stop playing on the display screen.

6. The method of claim 1, wherein the video player is configured to track at least one of a position of a cursor displayed on the display screen or a position of a finger or stylus in contact with the display screen.

7. The method of claim 1, wherein the video is configured to play on the display screen when the display screen is not being screenshared or screenshotted.

8. The method of claim 1, wherein the video includes an image frame representing the content element, and wherein the content element represents sensitive information.

9. The method of claim 1, wherein the video is configured to be played in a loop on the display screen.

10. The method of claim 1, wherein the video includes a transparent image frame and the content element represents sensitive information, and wherein the method further comprises:
outputting, using an operating system of the computing device, the content element to the display screen, wherein the video is configured to be overlaid on the content element on the display screen.

11. A system comprising:
at least one processor; and
at least one memory having programming instructions stored thereon, which, when executed by the at least one processor, cause the system to perform operations comprising:
receiving a video from an application server, wherein the video is associated with a content element and a digital rights management technology;
forming a HyperText Markup Language (HTML) element including the video received from the application server;
playing the video of the HTML element on a display screen;
receiving input data;
transmitting the input data to the application server;
receiving a determination that the input data represents unexpected input data, from the application server; and
in response to receiving the determination, causing the video of the HTML element to stop playing on the display screen.

12. The system of claim 11, wherein the unexpected input data represents data associated with a user unauthorized to view the video on the display screen.

13. The system of claim 11, wherein the input data represents at least one of:
movement of a mouse associated with a computing device;
movement of a cursor displayed on the display screen;
a position of the cursor displayed on the display screen;
an amount of time during which the video has been playing on the display screen;
an amount of time during which an eye of a user associated with the computing device has been directed at the display screen;
an amount of time during which the eye of the user has been directed at the video on the display screen;
movement of the eye of the user associated with the computing device; or
a position on the display screen of a finger or stylus, associated with the user, and in contact with the display screen.

14. The system of claim 11, wherein the determination that the input data represents unexpected input data represents a determination output from a machine learning model.

15. The system of claim 11, wherein causing the video of the HTML element to stop playing on the display screen comprises:
causing, using a video player and an operating system, the video of the HTML element to stop playing on the display screen.

16. The system of claim 11, wherein the video is configured to play on the display screen when the display screen is not being screenshared or screenshotted.

17. The system of claim 11, wherein the video includes an image frame representing the content element, and wherein the content element represents sensitive information.

18. The system of claim 11, wherein the video is configured to be played in a loop on the display screen.

19. The system of claim 11, wherein the video includes a transparent image frame and the content element represents sensitive information, and wherein the operations further comprise:
outputting, using an operating system, the content element to the display screen, wherein the video is configured to be overlaid on the content element on the display screen.

20. A method comprising:
receiving, using a browser module of a computing device, a video from an application server, wherein the video is associated with a content element and a digital rights management technology;
forming, using the browser module, a HyperText Markup Language (HTML) element including the video received from the application server;
playing, using a video player of the computing device, the video of the HTML element in a loop on a display screen associated with the computing device;
receiving, using the computing device, input data;
receiving, using the computing device, a determination that the input data represents unexpected input data, from the application server; and
in response to receiving the determination, causing, using the video player, the video of the HTML element to stop playing on the display screen.
